(19) United States
(12) Patent Application Publication
(10) Pub. No.: US 2011/0198966 A1
(43) Pub. Date: Aug. 18, 2011

(54) CAPACITIVE ELECTROMECHANICAL TRANSDUCER

(75) Inventors: Kazunari Fujii, Kawasaki-shi (JP); Takahiro Akiyama, Kawasaki-shi (JP); Hidemasa Mizutani, Sagamihara-shi (JP)

(73) Assignee: CANON KABUSHIKI KAISHA, Tokyo (JP)

(21) Appl. No.: 13/025,869

(22) Filed: Feb. 11, 2011

(30) Foreign Application Priority Data
Feb. 14, 2010 (JP) 2010-029598

(51) Int. Cl. H02N 1/00

(52) U.S. Cl. 310/300

(57) ABSTRACT

A capacitive electromechanical transducer has at least one cell. The cell includes a first electrode, a movable vibrating portion including a second electrode disposed opposite the first electrode with a space therebetween, and a supporting portion that supports the vibrating portion. In order to regulate the strength of a border portion between the vibrating portion and the supporting portion, a strength regulating portion is provided.

### BACKGROUND OF THE INVENTION

1. Field of the Invention

The present invention relates to a capacitive electromechanical transducer that performs at least one of the reception and transmission of an elastic wave such as an ultrasonic wave.

2. Description of the Related Art

In recent years, the research and development of a capacitive electromechanical transducer made using a micromachining technique has been advanced. A capacitive electromechanical transducer has a cell including a vibrating membrane supported at a distance from a lower electrode (first electrode), and an upper electrode (second electrode) disposed on the surface of the vibrating membrane. This is used, for example, as a capacitive micromachined ultrasonic transducer (CMUT). A CMUT is used as an array element consisting of about 200 to 4000 elements each of which consists of a plurality of (usually about 100 to 3000) cells. A CMUT performs the reception and transmission of an ultrasonic wave using a lightweight vibrating membrane. Compared to an electromechanical transducer using a piezoelectric element, the broadband characteristic can be easily obtained. Use of this CMUT makes it possible to obtain a higher-definition multidimensional signal. Therefore, it is receiving attention as a promising technique particularly in the field of medicine where ultrasonic diagnosis is used.

The principle of operation of a capacitive electromechanical transducer will be described. When transmitting an elastic wave such as an ultrasonic wave, a DC voltage and a minute AC voltage are applied in a superimposed manner between the lower electrode and the upper electrode. Due to this, the vibrating membrane vibrates and an elastic wave is generated. When receiving an elastic wave, the vibrating membrane is deformed by the elastic wave. So, the signal of the elastic wave is detected by the change in the capacitance between the lower electrode and the upper electrode due to the deformation. The sensitivity (signal amplitude) of a capacitive electromechanical transducer is inversely proportional to the square of the distance (gap) between the electrodes. Thus, in order to make a highly sensitive transducer, a narrow gap is necessary. For example, a method including providing a sacrifice layer having a thickness equal to a desired interelectrode distance, forming a vibrating membrane on the sacrifice layer, and removing the sacrifice layer is generally used as a method for forming a gap of a capacitive electromechanical transducer. Such a technique is disclosed in U.S. Pat. No. 6,426,582.

### SUMMARY OF THE INVENTION

In an aspect of the present invention, a capacitive electromechanical transducer includes a cell including a first electrode, a movable vibrating portion including a second electrode disposed opposite the first electrode with a space therebetween, and a supporting portion that supports the vibrating portion, and a strength regulating portion that is formed on a border portion between the vibrating portion and the supporting portion and regulates a strength of the border portion.

Further features of the present invention will become apparent from the following description of exemplary embodiments with reference to the attached drawings.

### BRIEF DESCRIPTION OF THE DRAWINGS

FIGS. 1A and 1B are sectional views showing the structure of first and second embodiments of capacitive electromechanical transducer according to the present invention.

FIGS. 2A to 2E are sectional views showing a method for making a capacitive electromechanical transducer according to the present invention.

### DESCRIPTION OF THE EMBODIMENTS

The embodiments of the present invention will be described. The important point of the capacitive electromechanical transducer of the present invention is that a strength regulating portion is formed on a border portion between a vibrating portion and a supporting portion and the mechanical strength of the vicinity of the border portion is thereby regulated or reinforced. Under this concept, the basic form of the capacitive electromechanical transducer of the present invention has the above-described configuration. On the basis of this basic form, the following embodiments are possible.

Typically, the vibrating portion includes the second electrode and a vibrating membrane that supports the second electrode. That is to say, the second electrode is formed on a vibrating membrane supported by the supporting portion (see the embodiments to be described later). Alternatively, a vibrating membrane formed of a conductive material may also serve as a second electrode. In this case, for example, on the first electrode is formed an insulating layer for providing insulation between the first electrode and the second electrode. The first electrode may be disposed on a substrate (see the embodiments to be described later), or a substrate formed of a conductive material such as a semiconductor such as silicon may also serve as a first electrode. The thickness of the vibrating membrane or the vibrating portion can be smaller than the height of the supporting portion. For example, the thickness of the vibrating membrane can be less than or equal to one tenth of the height of the supporting portion. In absolute terms, the thickness of the vibrating membrane can be 100 nm or less. The strength regulating portion may be a film thicker than the vibrating membrane.

The vibrating membrane and the supporting portion can be formed continuously of the same material (see the first embodiment described later). Such a configuration can be easily made by a method using surface micromachining (see the third embodiment to be described later). In this case, typically, the supporting portion includes the same membrane as the vibrating membrane and the strength regulating portion. Alternatively, the vibrating membrane and the supporting portion may be formed separately (see the second embodiment to be described later). Such a configuration can be made, for example, through a process of forming a cavity structure on a silicon substrate and bonding an SOI substrate. In this case, typically, an immovable portion that connects vibrating membranes of adjacent cells and is continuous with the vibrating membranes is formed on a supporting portion, and a strength regulating portion is formed thereon.

The first electrode used in the capacitive electromechanical transducer of the present invention can be formed of at least one of a conductor selected from Al, Cr, Ti, Au, Pt, Cu, Ag, W, Mo, Ta, Ni, and others, a semiconductor such as Si, and an alloy selected from AlSi, AlCu, AlTi, MoW, AlCr, TiN, AlSiCu, and others. The second electrode can be provided at least one of on the upper surface, on the lower surface, and inside of the vibrating membrane. As described above, when the vibrating membrane is formed of a conductor or a semiconductor, the vibrating membrane can also serve as a second electrode. The second electrode can be formed of the same conductor, semiconductor, or the like as the first electrode. The first electrode and the second electrodes may be formed of different materials.

The embodiments of capacitive electromechanical transducer of the present invention will be described with reference to the drawings.

### First Embodiment

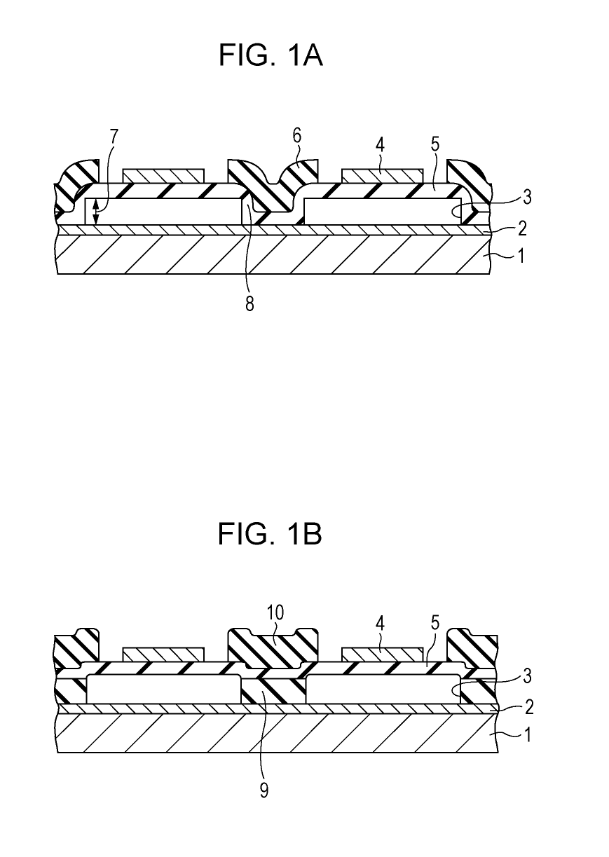

An electromechanical transducer of a first embodiment will be described. As shown in FIG. 1A, the electromechanical transducer of this embodiment has a lower electrode 2 that is a first electrode disposed on a substrate 1, and an upper electrode 4 that is a second electrode disposed opposite the lower electrode 2 with a predetermined space 3 therebetween. In addition, the electromechanical transducer has a vibrating membrane 5 that supports the upper electrode 4, a strength regulating portion 6, and a supporting portion 8. In this embodiment, the vibrating portion includes the upper electrode 4 and the vibrating membrane 5, and the vibrating membrane 5 and the supporting portion 8 are formed continuously of the same material. That is to say, the supporting portion 8 is in contact with the vibrating membrane 5 and the lower electrode 2 at the end portion (the edge portion including the corner portion) of the space 3, and supports the vibrating membrane 5 over the space 3. The strength regulating portion 6 is formed on the supporting portion 8 and the border portion between the vibrating membrane 5 and the supporting portion 8, and reinforces the mechanical strength of the vibrating membrane 5 and the supporting portion 8 around the end portion of the space 3.

The space 3 has, for example, a circular, square, or polygonal shape when viewed from above. The strength regulating portion 6 is formed around the space 3. A cell includes a lower electrode 2, a movable vibrating portion including an upper electrode 4 disposed opposite the lower electrode 2 with a space 3 therebetween, and a supporting portion 8 that supports the vibrating portion. Usually, an electromechanical transducer has a plurality of elements each of which includes one or more cells. Therefore, the strength regulating portion 6 is formed around the space 3 and between adjacent cells as shown in FIG. 1A. The operation of this embodiment is performed as described in the Description of the Related Art.

In this embodiment, for example, the height of the space 3 is 100 nm to 200 nm. The diameter of the space 3 is desirably, for example, 10 μm to 200 μm. The upper electrode 4 and the lower electrode 2 are formed of at least one of Al, Cr, Ti, Au, Pt, and Cu. Here, the vibrating membrane 5 is formed of silicon nitride but may be formed of another insulating material. The space 3 is kept in a depressurized state relative to the atmospheric pressure, and therefore the vibrating membrane 5 is concave (not shown).

By narrowing the gap between the electrodes 2 and 4, the change in capacitance due to the change of the vibrating membrane 5 in response to the input sound wave increases, and therefore high sensitivity can be achieved. Therefore, the thickness of the vibrating membrane 5 is desirably small. However, reducing the thickness of the vibrating membrane 5 weakens the mechanical strength of the vibrating membrane in the part where the vibrating membrane 5 deforms along the end portion of the space 3 (the border portion between the vibrating membrane 5 and the supporting portion 8) shown in FIG. 1A. Usually, for example, when the thickness of the vibrating membrane is three or more times larger than the height of the supporting portion, there is no problem in terms of mechanical strength. However, when the thickness of the vibrating membrane is smaller than the height of the supporting portion, the decreased mechanical strength of the vibrating membrane poses a problem. Due to the decreased mechanical strength, the detachment of the vibrating membrane may occur, or the pressurized state of the space may not be maintained. Here, the height of the supporting portion 8 is the distance from the upper surface of the lower electrode 2 to the lower surface of the vibrating membrane 5 as shown by an arrow 7 in FIG. 1A, and is equal to the height of the space 3 when the vibrating membrane 5 is not deformed.

In this embodiment, for example, the thickness of the vibrating membrane 5 is 100 nm or 20 nm. In the former case and when the height of the space 3 is 100 nm as described above, the thickness of the vibrating membrane 5 is about equal to the height of the supporting portion. In the latter case and when the height of the space 3 is 200 nm as described above, the thickness of the vibrating membrane 5 is about one tenth of the height of the supporting portion. So, the strength regulating portion 6 is disposed near the border portion between the vibrating membrane 5 and the supporting portion 8 where the mechanical strength of the vibrating membrane 5 is particularly low. Especially when the thickness of the vibrating membrane 5 is about 100 nm or less, the region where the strength regulating portion 6 is formed is desirably large. Therefore, in the latter case, it is desirable that the region where the strength regulating portion 6 is formed be larger and the thickness of the strength regulating portion 6 be within a range of 100 nm to 1000 nm. In the former case, the thickness of the strength regulating portion 6 can be smaller than this. In this embodiment, the strength regulating portion 6 has a uniform thickness. However, the thickness may vary from part to part. Here, the strength regulating portion 6, like the vibrating membrane 5, is formed of silicon nitride but may be formed of another material having the same mechanical characteristic as silicon nitride.

Thus, the mechanically weak deforming part of the vibrating membrane 5 can be reinforced with the strength regulating portion 6. By making the thickness of the vibrating membrane 5 smaller (for example, equal to or less than the height of the supporting portion 8) and thereby reducing the distance between the electrodes 2 and 4, high sensitivity can be achieved. The reliability can be improved, for example, the detachment of the vibrating membrane 5 can be reduced and the depressurized state of the space 3 can be maintained over a long time.

### Second Embodiment

An electromechanical transducer of a second embodiment will be described. As shown in FIG. 1B, the electromechanical transducer of this embodiment has a lower electrode 2 that is a first electrode disposed on a substrate 1, and an upper electrode 4 that is a second electrode disposed opposite the lower electrode 2 with a predetermined space 3 therebetween. In addition, the electromechanical transducer has a vibrating membrane 5 that supports the upper electrode 4, a supporting portion 9 that supports the vibrating membrane 5, and a strength regulating portion 10. In this embodiment, the vibrating portion also includes the upper electrode 4 and the vibrating membrane 5. However, the vibrating membrane 5 and the supporting portion 9 are formed separately, and an immovable portion that connects adjacent vibrating membranes 5 and is continuous with the vibrating membranes 5 is formed on the supporting portion 9. The strength regulating portion 10 is formed so as to extend from on the immovable portion that connects adjacent vibrating membranes 5 to the border portion between the vibrating membrane 5 and the supporting portion 9, and reinforces the mechanical strength of the vibrating membrane 5 around the end portion of the space 3.

In this embodiment, by disposing the supporting portion 9 on the lower electrode 2, the vibrating membrane 5 can be held substantially flatly, and therefore the deforming part of the vibrating membrane 5 can be reduced. Thus, the decrease in mechanical strength can be avoided to some extent. The stress concentrates in the area where the vibrating membrane 5 and the supporting portion 9 are in contact. Therefore, when the thickness of the vibrating membrane 5 is small, the detachment of the vibrating membrane may occur, or the pressurized state of the space 3 may not be maintained. So, as described above, the strength regulating portion 10 is provided.

In this embodiment, for example, the supporting portion 9 is formed of silicon nitride, the height of the supporting portion 9 is 200 nm, which is equal to the height of the space 3, and the thickness of the vibrating membrane 5 is 100 nm or 20 nm. The supporting portion 9 desirably has the same height as the space 3. However, if the height of the supporting portion 9 is smaller than twice the height of the space 3, the decrease in mechanical strength of the deforming part of the vibrating membrane 5 can be avoided to some extent. The thickness of the vibrating membrane 5 is, for example, 100 nm. However, if the thickness of the vibrating membrane 5 is smaller than the height of the space 3, the sensitivity can be improved.

In this embodiment, when the thickness of the vibrating membrane 5 is 100 nm and the height of the space 3 is 200 nm as described above, the thickness of the vibrating membrane 5 is about one half of the height of the supporting portion. When the thickness of the vibrating membrane 5 is 20 nm, the thickness of the vibrating membrane 5 is about one tenth of the height of the supporting portion. So, the strength regulating portion 10 is disposed. Especially when the thickness of the vibrating membrane is about 100 nm or less, the region where the strength regulating portion 10 is formed is desirably large. When the thickness of the vibrating membrane 5 is 20 nm, the thickness of the strength regulating portion 10 is desirably within a range of 100 nm to 1000 nm. Here, the strength regulating portion 10 also has a uniform thickness. However, the thickness may vary from part to part. The strength regulating portion 10 is formed of silicon nitride but may be formed of another material having the same mechanical characteristic as silicon nitride. Except for the above, this embodiment is the same as the first embodiment.

Thus, in this embodiment, the mechanically weak deforming part of the vibrating membrane 5 can also be reinforced with the strength regulating portion 10. Therefore, high sensitivity can be achieved and the reliability can be improved.

### Third Embodiment

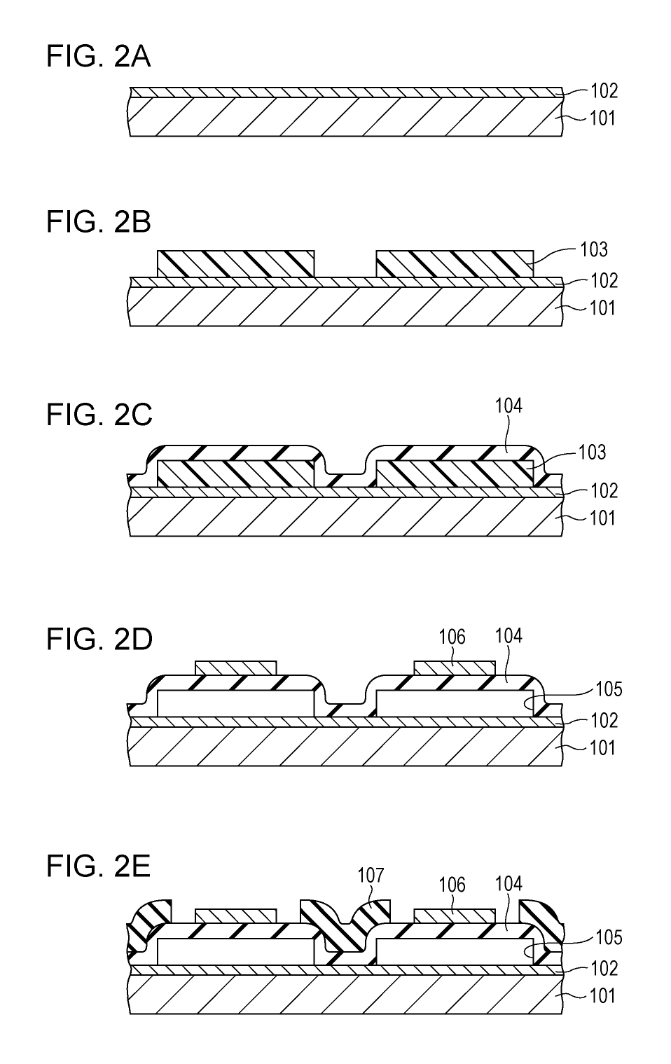

A third embodiment concerning a method for making a CMUT to which the present invention can be applied will be described. The shapes, materials, numerical values, and making process described below are illustrative only, and may be arbitrarily changed as a matter of design choice as long as they meet the requirements of the present invention. A method using surface micromachining will be described as a method for making the electromechanical transducer of the first embodiment. FIGS. 2A to 2E are schematic views illustrating a making process.

First, a Si substrate 101 is prepared. Next, a film of a conductor, for example, a metal or a doped semiconductor is formed by vacuum deposition, sputtering, or CVD, and then lower electrodes 102 are formed by photolithography and etching (FIG. 2A). Next, a sacrifice layer 103 is formed. First, a film of amorphous silicon having a thickness of 100 nm is formed by PECVD. A pattern of the sacrifice layer 103 that becomes spaces is formed by photolithography and etching (FIG. 2B). Next, vibrating membranes and supporting portions are formed. Vibrating membranes 104 and supporting portions that are silicon nitride films having a thickness of 100 nm are formed by PECVD (FIG. 2C). Next, etching holes (not shown) are formed in the silicon nitride films 104 by photolithography and etching. These are inlets for allowing etching liquid to enter the sacrifice layer. Next, the substrate is soaked in Tetramethyl Ammonium Hydroxide (TMAH). The TMAH etches the amorphous silicon that is a sacrifice layer 103. Thus, spaces 105 are formed.

Next, a film of a metal such as aluminum is formed, and patterning of the upper electrodes 106 is performed by photolithography and etching (FIG. 2D). Further, strength regulating portions 107 that are silicon nitride films are formed by PECVD. By performing film formation under a vacuum atmosphere, the etching holes are sealed and the space 105 of each cell can be vacuum sealed (FIG. 2E). In the film formation of the strength regulating portions 107, in order to form the strength regulating portions like those of the first embodiment, strength regulating portions are left only in the vicinities of the supporting portions using a liftoff process or the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-029598 filed Feb. 14, 2010, which is hereby incorporated by reference herein in its entirety.

What is claimed is:

1. A capacitive electromechanical transducer comprising:
a cell including a first electrode, a movable vibrating portion including a second electrode disposed opposite the first electrode with a space therebetween, and a supporting portion that supports the vibrating portion; and
a strength regulating portion that is formed on a border portion between the vibrating portion and the supporting portion and regulates a strength of the border portion.

2. The transducer according to claim 1, wherein the vibrating portion includes a vibrating membrane that supports the second electrode, and the second electrode.

3. The transducer according to claim 2, wherein a thickness of the vibrating membrane is smaller than a height of the supporting portion.

4. The transducer according to claim 2, wherein the strength regulating portion is a film thicker than the vibrating membrane.

5. The transducer according to claim 2, wherein the vibrating membrane and the supporting portion are formed continuously of a same material.

6. The transducer according to claim 2, wherein the vibrating membrane and the supporting portion are formed separately, and an immovable portion that connects vibrating membranes of adjacent cells and is continuous with the vibrating membranes is formed on the supporting portion.
